(19) United States
(12) Patent Application Publication
(10) Pub. No.: US 2006/0221798 A1
(43) Pub. Date: Oct. 5, 2006

(54) Optical disk device and adjusting method therefor

(76) Inventors: Yasuyuki Tsukioka, Nagano (JP); Hiroshi Sakai, Nagano (JP)

Correspondence Address: CANTOR COLBURN, LLP, 55 GRIFFIN ROAD SOUTH, BLOOMFIELD, CT, 06002, US

(21) Appl. No.: 11/393,492

(22) Filed: Mar. 30, 2006

(30) Foreign Application Priority Data
Apr. 1, 2005 (JP) 2005-106568

(51) Int. Cl. G11B 7/135

(52) U.S. Cl. 369/112.01

(57) ABSTRACT

An optical disk device, for use with an optical disk, may include a laser light source, a photo-detector, and an optical system for structuring a forward path in which a laser beam is guided to the optical disk and a return path in which a return light beam is guided to the photo-detector. The optical system may further include a sensor lens which gives astigmatism to the return light beam to generate a focusing error signal by an astigmatism method. The optical disk device may be provided with an angular position adjusting mechanism for adjusting an angular position of the sensor lens around the optical axis of the sensor lens.

### CROSS REFERENCE TO RELATED APPLICATION

The present invention claims priority under 35 U.S.C. §119 to Japanese Application No. 2005-106568 filed Apr. 1, 2005, which is incorporated herein by reference.

### FIELD OF THE INVENTION

An embodiment of the present invention may relate to an optical disk device for performing reproduction of information recorded in an optical disk or recording information on an optical disk.

### BACKGROUND OF THE INVENTION

Various structures have been proposed to detect signals with respect to an optical disk. Even when various structures are utilized, an optical disk device basically includes a laser light source, a photo-detector and an optical system for forming a forward path that guides a laser beam emitted from the laser light source to an optical disk and a return path that guides a return light beam reflected by the optical disk to the photo-detector.

In the optical disk device as described above, information recorded on an optical disk is reproduced on the basis of a signal detected by the photo-detector and a focusing error signal and a tracking error signal are generated. Among the methods for a signal detection, the push-pull method is frequently used as a method for detecting a tracking error. Further, in the push-pull method, since a tracking error signal may not be accurately generated when an objective lens is moved in a tracking direction or when the objective lens is tilted, the DPP (Differential Push-Pull) method is sometimes utilized. According to the DPP method, a diffraction element for generating diffracted light beams is disposed on an optical path directing to an optical disk from a laser diode to cause a sub-beam comprised of +1 st-order light beam, a main beam comprised of O-order light beam, and a sub-beam comprised of −1st-order light beam to be converged at positions which are shifted in the tangential direction of a track that forms pits of the optical disk and which are radially shifted by a half track. The reflected lights of the main beam and the sub-beams are received with three light receiving elements and offset is canceled by the push-pull signal.

Further, with respect to a focusing error signal, astigmatism is applied by a sensor lens to the return light beam from the optical disk and a spot with a light and dark pattern as shown in FIG. 4(a) is formed on a photo-detector. In the astigmatism method, as shown in FIG. 4(b), when an objective lens is positioned at the focusing position, a circular spot S0 is formed on the four-divided element. Further, when the objective lens is positioned too near to the optical disk, for example, an elliptical spot S1 which is inclined at 45° on the left side is formed and, when the objective lens is positioned too far from the optical disk, an elliptical spot S2 which is inclined at 45° on the right side is formed. Therefore, when respective detection results in respective light receiving faces of the four-divided element are set to be “A”, “B”, “C” and “D”, the focusing error signal can be obtained by performing the following operation by using these detection results;
focusing error signal=(A+C)−(B+D).
In this case, the inclination of the elliptical spot is set to be an optimum value, for example, at 45° by the sensor lens.

In the optical disk device as described above, the sensor lens is structured so as to take the aberration of optical components used in the optical system in the optical disk device into consideration. Therefore, as shown on the left side in FIG. 4(c), when the objective lens is at the focusing position, a focusing error signal should be zero. However, since the aberration of an optical component may vary by each production lot or the like, when the aberration of the optical component used in an optical system largely differs from its anticipated quantity, the direction of a light and dark pattern of the spot inclines as shown on the right side in FIG. 4 (c). Therefore, although the objective lens is located at the focusing position, for example, a signal of a positive value is generated as a focusing error signal and thus it may be detected such that the objective lens is shifted from the focusing position. This leakage of the push-pull to a focusing error signal is referred to as a focusing error/tracking error cross talk, which causes a focus servo to be unstable.

### BRIEF DESCRIPTION OF THE INVENTION

In view of the problems described above, an embodiment of the present invention may advantageously provide an optical disk device, for use with an optical disk, capable of preventing the occurrence of a cross talk between error signals without adding a correction circuit when a focusing error signal is detected by an astigmatism method, and an adjusting method for the optical disk device.

Thus, according to an embodiment of the present invention, there may be provided an optical disk device, for use with an optical disk, including a laser light source, a photo-detector, and an optical system for structuring a forward path in which a laser beam emitted from the laser light source is guided to the optical disk and a return path in which a return light beam reflected by the optical disk is guided to the photo-detector. The optical system includes a sensor lens which gives astigmatism to the return light beam to generate a focusing error signal by an astigmatism method. The optical disk device further includes an angular position adjusting mechanism for adjusting the angular position of the sensor lens around the optical axis of the sensor lens.

In accordance with an embodiment, even when aberrations provided in the respective optical elements which are actually used in the optical system differ from the aberrations as designed and a spot formed in the photo-detector through the sensor lens is inclined, the inclination can be corrected by rotating the sensor lens around its optical axis. Therefore, since the leakage of a push-pull signal to a focusing error signal which causes the inclination can be prevented even when a correction circuit is not used, unstable operation caused by the focusing error/tracking error cross talk does not occur. Therefore, information can be surely recorded on a DVD-RAM or the like.

In accordance with an embodiment, the angular position adjusting mechanism includes a cylindrical lens holder which holds the sensor lens and a holder support portion which rotatably supports the lens holder around the optical axis of the sensor lens. According to the structure described above, when the lens holder is rotated along the holder support portion around the axial line, the angular position of sensor lens can be adjusted without shifting the optical axis of the sensor lens. More specifically, it is preferable that the holder support portion is provided with a circular arc-shaped support portion in cross section which supports the lens holder and the center of curvature of the circular arc-shaped support portion is coincided with the optical axis of the sensor lens. Further, it is preferable that an urging member for urging the lens holder against the circular arc-shaped support portion is provided and the lens holder is provided with a recessed part or a projecting part for adjusting the angular position of the lens holder.

Further, in accordance with an embodiment of the present invention, there may be provided an adjusting method for an optical disk device including a step of preparing an optical disk device provided with a laser light source, a photo-detector, an optical system for structuring a forward path in which a laser beam emitted from the laser light source is guided to an optical disk and a return path in which a return light beam reflected by the optical disk is guided to the photo-detector, and a sensor lens which is included in the optical system and which gives astigmatism to the return light beam to generate a focusing error signal by an astigmatism method. The adjusting method further includes a step of correcting the deviation of inclination of a spot on the photo-detector which is caused by the aberration of the optical system by adjusting the angular position of the sensor lens around an optical axis of the sensor lens.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a schematic perspective view showing a structure of an optical disk device in accordance with an embodiment of the present invention.

FIG. 2 is an enlarged perspective view showing a portion around a sensor lens in an optical disk device in accordance with an embodiment.

FIGS. 3(a) through 3(e) are perspective views respectively showing a structural example of a portion around a sensor lens in an optical disk device in accordance with an embodiment.

FIG. 4(a) is an explanatory view of a light-and-dark pattern which is included in a return light beam from an optical disk, FIG. 4(b) is an explanatory view of an astigmatism method, FIG. 4(c) is an explanatory view showing the effect that the aberration of an optical system gives to a focusing error signal, and FIG. 4(d) is an explanatory view showing a state in which the inclination of a spot is adjusted by applying the present invention.

### DETAILED DESCRIPTION OF THE PREFERRED EMBODIMENTS

An embodiment of the present invention will be described below with reference to the accompanying drawings.

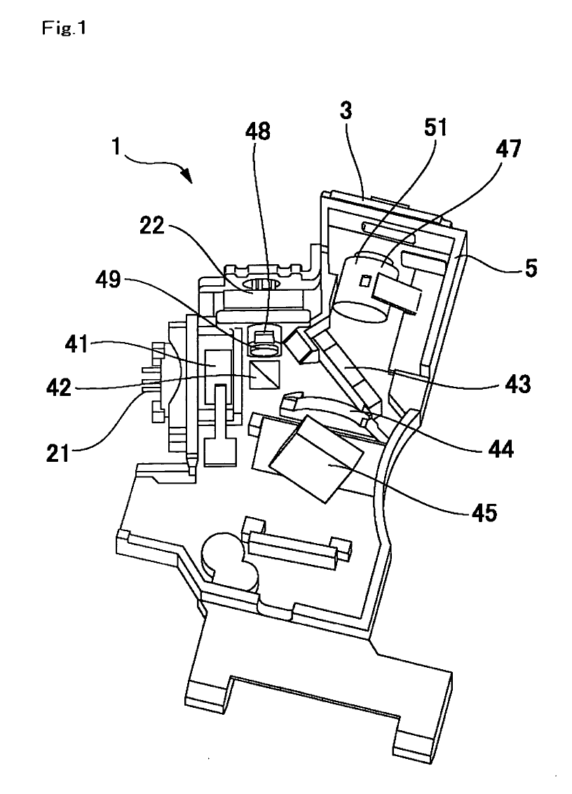

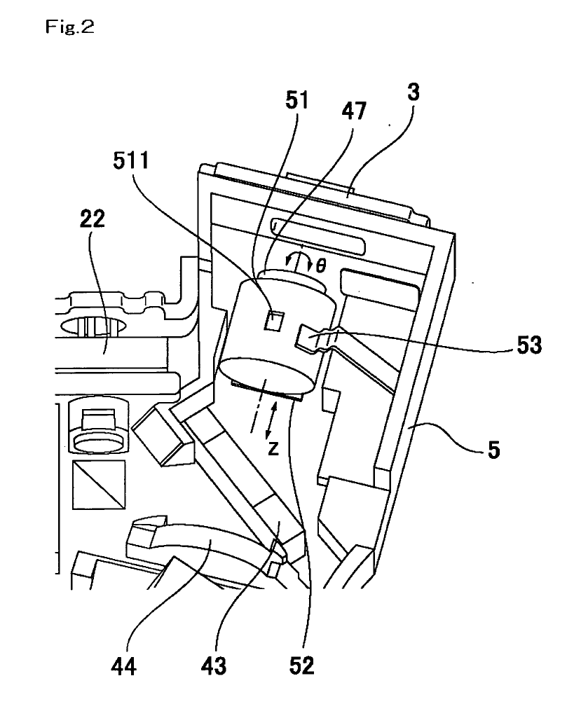

FIG. 1 is a schematic perspective view showing a structure of an optical disk device in accordance with an embodiment and FIG. 2 is an enlarged perspective view showing a portion around a sensor lens in an optical disk device in accordance with an embodiment.

In FIGS. 1 and 2, an optical disk device 1 in accordance of an embodiment is provided with a first laser light source 21 for emitting a laser light beam, for example, with a wavelength of 650 nm and a photo-detector 3 on a device frame 5. The optical disk device 1 is also provided with an optical system 40 including a grating 41, an optical path synthesizing prism 42, a half mirror 43, a collimating lens 44, a rising mirror 45, and an objective lens (not shown) from the laser light source 21 to an optical disk (not shown). A forward path for guiding the laser beam emitted from the laser light source 21 to the optical disk is structured by these optical elements. Further, the optical system 40 is provided with a second laser light source 22 for emitting a laser beam, for example, with a wavelength of 780 nm to the optical path synthesizing prism 42. A grating 48 and a relay lens 49 are disposed between the second laser light source 22 and the optical path synthesizing prism 42. Therefore, a forward path for guiding the laser beam emitted from the second laser light source 22 to the optical disk is also structured.

The optical system 40 is provided with a sensor lens 47 between the half mirror 43 and the photo-detector 3. A return path for guiding the return light beam reflected by the optical disk to the photo-detector 3 is structured by the objective lens, the rising mirror 45, the collimating lens 44, the half mirror 43 and the sensor lens 47.

The photo-detector 3 is used to generate a focusing error signal and a tracking error signal when a return light beam reflected by the optical disk is detected to record and reproduce information. These focusing error signal and tracking error signal are fed back to an objective lens drive device (not shown).

In the disk device 1 structured as described above, a DVD-RAM or the like is used as an optical disk. In a DVD-RAM, a land and a groove with wobble (undulation) are alternately formed in a concentric manner (not shown) and both the land and the groove are used as a track on which a pit is formed.

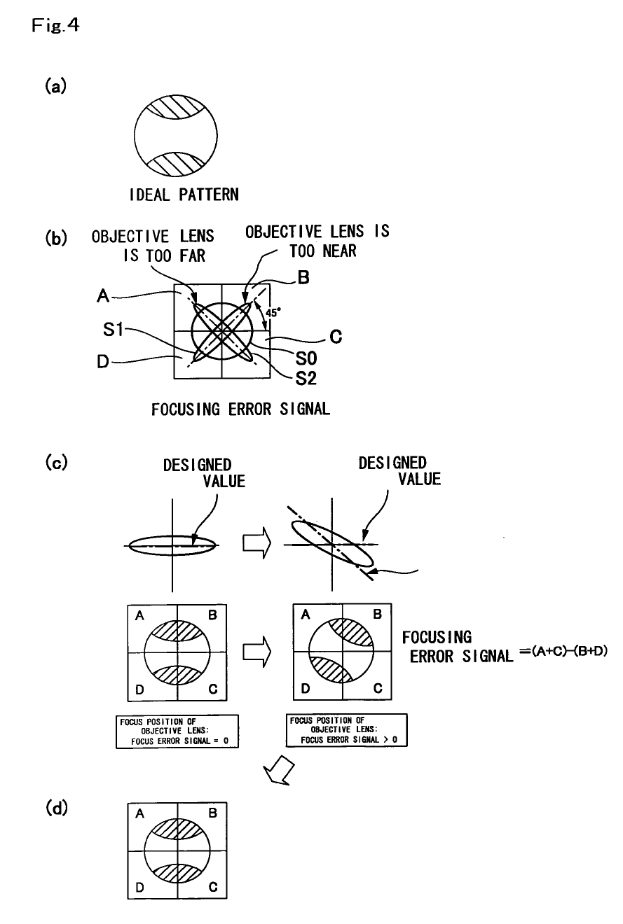

In the disk device 1 in accordance with this embodiment, a push-pull method, a DPP method or the like is employed to generate a tracking error signal and an astigmatism method described with reference to FIGS. 4(a) through 4(c) is used to generate a focusing error signal. Therefore, spots S0, S1, S2 of the return light beam shown in FIG. 4(b) should be formed on the photo-detector 3. However, the respective optical elements which are used in the optical system 40 may be provided with aberration different from that as designed. In this case, as shown in FIG. 4(c), the inclination of the elliptical spot may be shifted from 45° in the initial stage of producing. This shift causes a push-pull signal to largely leak into a focusing error signal and thus, in this embodiment, the sensor lens 47 is rotated around the optical axis and, as shown in FIG. 4(d), its angular position is adjusted to correct the inclination of the spot which is formed on the photo-detector 3 through the sensor lens 47.

For example, in a DVD-RAM, the state where the center position of a spot is on a groove is set to be the reference position, the ratios of a focusing error signal included in a push-pull signal (value corresponding to focusing error/tracking error cross talk) are obtained by simulation when a spot is shifted by 0.615 μm (½ track pitch) on an inner side and on an outer side of the optical disk 10 from the reference position. As a result when the ratio of an error signal in the case that the sensor lens 47 is disposed as designed is set to be “1”, the ratio in the case that the sensor lens 47 is rotated by 3° in a clockwise direction around the optical axis and the ratio in the case that the sensor lens 47 is rotated by 3° in a counterclockwise direction around the optical axis are obtained as follows.

Case as designed: 1.003

Case rotated by 3° in the clockwise direction: 1.283

Case rotated by 3° in the counterclockwise direction: 0.74

In other words, when the sensor lens 47 disposed as designed is, for example, rotated by 3° in a counterclockwise direction, it is confirmed that the ratio is reduced. Therefore, since the leakage of the push-pull signal into a focusing error signal can be reduced, unstable operation due to the focusing error/tracking error cross talk does not occur and information can be surely recorded on a DVD-RAM or the like.

In order to perform the above-mentioned adjustment, in the optical disk device 1 in accordance with an embodiment, as shown in FIG. 2, an optical-axis-direction position adjusting mechanism is provided to perform a positional adjustment in an optical axis direction (shown by the arrow “Z”) of the sensor lens 47 and an angular position adjusting mechanism is provided to adjust the angular position (shown by the arrow θ) of the sensor lens 47 around its optical axis. More specifically, the sensor lens 47 is held by a cylindrical lens holder 51 and the lens holder 51 is disposed on a groove 52 (holder support portion) extending in the optical axis direction. Further, the outer peripheral face of the lens holder 51 is urged toward the groove 52 by a flat spring 53 which is formed to be bent at two positions. A small hole 511 is formed on the outer peripheral face of the lens holder 51. In this case, the member which urges the lens holder 51 is not limited to a flat spring member but may utilize other known member which is capable of urging the lens holder 51. Further, a recessed part may be alternatively used as the small hole 511 and, in this specification, a hole may be interpreted as the recessed part.

In this state, when a jig is inserted into the hole 511 to move the lens holder 51 along the optical axis “L” as shown by the arrow “Z”, the positional adjustment in the optical axis direction of the sensor lens 47 can be performed.

Further, when the jig is inserted into the hole 511 to turn the lens holder 51 around the optical axis as shown by the arrow θ, the angular position of the sensor lens 47 around the optical axis can be adjusted. In this case, the groove 52 serves as a holder support portion which rotatably supports the lens holder 51 around the optical axis of the sensor lens 47 and thus the optical axis “L” of the sensor lens 47 does not shift even when the lens holder 51 is rotated around the optical axis.

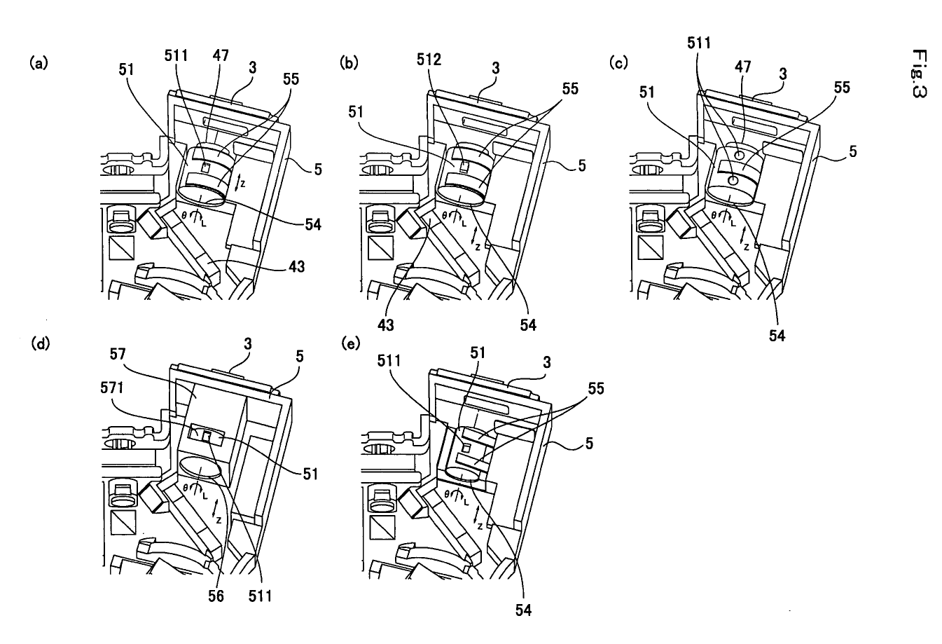

FIGS. 3(a) through 3(e) are explanatory views of position adjusting mechanisms for the sensor lens which is assembled into an optical disk device to which the present invention is applied.

In the optical disk device shown in FIG. 3(a), in order to structure the optical-axis-direction position adjusting mechanism for performing positional adjustment in the optical axis direction (shown by the arrow “Z”) of the sensor lens 47 and the angular position adjusting mechanism for adjusting the angular position (shown by the arrow θ) of the sensor lens 47 around the optical axis, the sensor lens 47 is held by the cylindrical lens holder 51 and the lens holder 51 is disposed on a groove 54 (holder support portion) which is formed in a circular arc-shape in cross section. The groove 54 is extended in the optical axis direction and the center of the curvature of the groove 54 is coincided with the optical axis of the sensor lens 47. Further, the outer peripheral face of the lens holder 51 is urged toward the groove 54 by two flat springs 55 which are formed in a curved shape. In accordance with an embodiment, a small hole 511 is formed in the outer peripheral face of the lens holder 51. Therefore, when a jig is inserted into the hole 511 to move the lens holder 51 along the optical axis L as shown by the arrow “Z”, the positional adjustment in the optical axis direction of the sensor lens 47 can be performed. Further, when the jig is inserted into the hole 511 to turn the lens holder 51 around the optical axis as shown by the arrow θ, the positional adjustment of the sensor lens 47 around the optical axis can be performed. In this case, the groove 54 serves as the holder support portion which rotatably supports the lens holder 51 around the optical axis of the sensor lens 47 and thus the optical axis “L” of the sensor lens 47 does not shift even when the lens holder 51 is rotated around the optical axis.

In an optical disk device shown in FIG. 3(b), a small projection (or a small protruded part) 512 is formed on the outer peripheral face of the lens holder 51. Other structure is similar to that shown in FIG. 3(a) and thus its description is omitted. When a jig is engaged with the projection 512 to move the lens holder 51 along the optical axis L as shown by the arrow “Z”, the positional adjustment in the optical axis direction of the sensor lens 47 can be performed. Further, the jig is engaged with the projection 512 to turn the lens holder 51 around the optical axis as shown by the arrow θ, the angular position of the sensor lens 47 around the optical axis can be adjusted.

In an optical disk device shown in FIG. 3(c), two small holes (recessed part) 511 are formed in the outer peripheral face of the lens holder 51. The other structures are similar to those shown in FIG. 3(a) and thus redundant description is omitted.

In the optical disk device shown in FIG. 3(d), in order to structure the optical-axis-direction position adjusting mechanism for performing positional adjustment in the optical axis direction (shown by the arrow “Z”) of the sensor lens (not shown) and the angular position adjusting mechanism for adjusting the angular position (shown by the arrow θ) of the sensor lens 47 around the optical axis, the sensor lens is held by the cylindrical lens holder 51 and this lens holder 51 is disposed in a circular hole 56 in cross section (holder support portion). The hole 56 is formed so as to be extended in the optical axis direction and the center axial line of the hole 56 is coincided with the optical axis of the sensor lens 51. Further, a window 571 for exposing the hole 511 formed in the outer peripheral face of the lens holder 51 is formed in a wall 57 surrounding the lens holder 51. Therefore, when a jig is inserted into the hole 511 from the window 571 to move the lens holder 51 along the optical axis L as shown by the arrow “Z”, the positional adjustment in the optical axis direction of the sensor lens can be performed. Further, the jig is inserted into the hole 511 to turn the lens holder 51 around the optical axis as shown by the arrow θ, the angular position of the sensor lens can be adjusted. In this case, the hole 56 serves as the holder support portion which rotatably supports the lens holder 51 around the optical axis of the sensor lens and thus the optical axis “L” of the sensor lens does not shift even when the lens holder 51 is turned around the optical axis.

In an optical disk device shown in FIG. 3(e), the outer peripheral face of the lens holder 51 is pressed against the groove 54 by flat springs 55 formed in a flat plate shape. Other structure is similar to that shown in FIG. 3(a) and thus its description is omitted. Also in the case which is structured as described above, the positional adjustment in the optical axis direction of the sensor lens can be performed and the angular position of the sensor lens around the optical axis can be adjusted.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. An optical disk device for use with an optical disk comprising:
a laser light source;
a photo-detector;
an optical system for structuring a forward path in which a laser beam emitted from the laser light source is guided to the optical disk and a return path in which a return light beam reflected by the optical disk is guided to the photo-detector,
a sensor lens which is included in the optical system and which gives astigmatism to the return light beam to generate a focusing error signal by an astigmatism method; and
an angular position adjusting mechanism for adjusting an angular position of the sensor lens around the optical axis of the sensor lens.

2. The optical disk device according to claim 1, wherein the angular position adjusting mechanism comprises:
a cylindrical lens holder which holds the sensor lens; and
a holder support portion which rotatably supports the lens holder around the optical axis of the sensor lens.

3. The optical disk device according to claim 2, wherein the holder support portion is provided with a circular arc-shaped support portion in cross section which supports the lens holder and a center of curvature of the circular arc-shaped support portion is coincided with the optical axis of the sensor lens.

4. The optical disk device according to claim 3, further comprising a urging member for urging the lens holder against the circular arc-shaped support portion, wherein the lens holder is provided with a recessed part or a protruded part for adjusting the angular position of the lens holder.

5. An adjusting method for an optical disk device comprising:
preparing an optical disk device comprising:
a laser light source;
a photo-detector;
an optical system for structuring a forward path in which a laser beam emitted from the laser light source is guided to an optical disk and a return path in which a return light beam reflected by the optical disk is guided to the photo-detector,
a sensor lens which is included in the optical system and which gives astigmatism to the return light beam to generate a focusing error signal by an astigmatism method; and
correcting deviation of inclination of a spot on the photo-detector which is caused by aberration of the optical system by adjusting angular position of the sensor lens around an optical axis of the sensor lens.
